(19) United States
(12) Patent Application Publication
(10) Pub. No.: US 2003/0122557 A1
(43) Pub. Date: Jul. 3, 2003

(54) Absorbent structure, particularly a sensor, provided with a thin film layer of not monomeric phtalocyanine and/or phtalocynine derivatives and a method for regenerating it

(76) Inventors: Aldo Capobianchi, Rome (IT); Maria Paoletti, Rome (IT); Giovanni Pennesi, Rome (IT); Gentilina Rossi, Rome (IT)

Correspondence Address: YOUNG & THOMPSON, 745 SOUTH 23RD STREET 2ND FLOOR, ARLINGTON, VA, 22202

(21) Appl. No.: 10/181,694

(22) PCT Filed: Jan. 11, 2001
(86) PCT No.: PCT/IT01/00005

(30) Foreign Application Priority Data
Jan. 19, 2000 (IT) RM2000A000028

(51) Int. Cl. G01N 27/12

(52) U.S. Cl. 324/691; 73/31.05; 257/432; 438/14

(57) ABSTRACT

This invention relates to an absorbant structure (2) comprising a sensitive component (3), provided with a thin film layer of not monomeric phtalocyanine and/or phtalocyanine derivatives, and a light source (5), arranged in such a position as to be adapted to irradiate said thin film layer of the sensitive component (3), the thickness of said thin film layer being not greater than 100 nanometers, said light source emitting light having a wavelength in the range of 180 to 600 nanometers. The invention also relates to a regeneration process for said absorbent structure (2).

This invention relates to an absorbent structure, particularly a sensor, provided with a thin film layer of not monomeric phtalocyanine and/or phtalocyanine derivatives and a regeneration method which causes desorption of a previously absorbed gas from said layer by irradiating it, the resulting absorbent structure being extremely selective in respect of a specific gas, highly sensitive, completely reversible, long lasting, reliable, easily manufacturable and inexpensive.

The application of such a structure is particularly advantageous in a sensor designed for detecting the presence of nitrogen dioxide, in respect of which some preferred embodiments of this invention will be hereinbelow described by way of exemplification not by way of limitation, since those skilled in the art will be immediately capable to modify the structure so as to make it adapted to detect gaseous chemical substances other than nitrogen dioxide. Those skilled in the art will be also immediately capable to exploit the regeneration method for applications other than detection applications based upon employment of sensors.

It is known that the environment monitoring for controlling both the execution conditions of industrial processes and the environment quality has presently got a high relevance. Noticeable human and economic resources are presently being dedicated to the development of sensors adapted to particularly detect specific chemical substances in gaseous environments.

When the control of the execution conditions of industrial processes is involved, the concerned sensor can be operated such that the concentration value of a chemical substances be maintained in a suitable range or, when the environment quality control is involved, they can be operated in order to detect whether the maximum allowable value of such concentration is exceeded, thereby indicating an emergency situation. The detection should be selective in respect of a specific chemical substance to be revealed, which means that it should not be affected by other chemical substances that might be mixed therewith.

At present, the most largely utilized sensors, generally manufactured by JAPAN or U.S. manufacturers, are based upon semiconductor oxides, such as thin films of tin oxide (SnO₂), provided with sophisticated electronic devices, which are adapted to detect chemical substances, particularly pollutant substances, such as nitrogen oxides (NOₓ), carbon monoxide (CO) and cyclic aromatics.

Such sensors, however, have some drawbacks.

First of all, the semiconductor oxide based sensors are scarcely reliable as a function of the time; in fact, when it is desired to reset the initial responsivity conditions in respect to a specific chemical substance to be detected, which is carried out by heating the sensor, its properties are jeopardized and a dangerous operation condition is eventually established.

Similar drawbacks characterize all sensors based upon ceramic materials, which are almost exclusively utilized for control of very high operation temperature processes, such as combustion processes in motor vehicles.

Noticeable attention has been recently dedicated to molecular organic or metallorganic systems, such phtalocyanine (Pc) and its derivatives, whose particular electronic structure promotes a different mechanism for interaction with chemical substances to be detected.

In detail, as described in C. C. Leznoff and A. B. Lever (Eds.) “Phtalocyanines, Properties and Applications”, Vol. 1-3, VCH, New York 1989-1993, phtalocyanine is a planar, substantially square shaped molecule, comprising benzene rings that create, above and under the molecular plane, a high electronic charge density capable to attract suitable molecules, preferably having a small dimension wit respect to the dimensions of the phtalocyanine molecule, such as particularly the nitrogen oxides, thereby generating very strong reactions.

In principle, monomeric phtalocyanine layers, deposited as thin films, could be utilized in the field of optical sensors and sensor based upon a conductivity measure, in order to detect the concentration of the gaseous chemical substance to be revealed by measuring the variation of the optical density or the variation of the electrical conductivity, respectively, of the monomeric phtalocyanine layers.

However, the monomeric phtalocyanine layers have some characteristics that inhibit them to be utilized as sensitive components of sensors.

In the first place, since they have a different stability with respect to oxides, subjecting phtalocyanine to some treatments is more cumbersome and difficult in comparison to the materials of conventional sensors.

Additionally, since the interaction which develops between the phtalocyanine molecule and the electronically attracted molecule is very strong, it is not reversible at room temperature, thereby making such material not re-useable as a sensor.

Further studies have been carried out on phtalocyanine derivatives, such as:

phtalocyanine oligomers, for instance, dimers,

phtalocyanine polymers,

phtalocyanine complexes with “sandwich” type crystal structure, in which two phtalocyanine rings are coupled by means of an intermediary atom, and

phtalocyanine complexes with “bridge” crystal structure, in which two phtalocyanine molecules are coupled by means of at least one intermediary atom and/or at least an intermediary molecule.

The phtalocyanine derivatives, even though they maintain the same electronic interaction mechanisms and the same sensitivity and selectivity characteristics as the monomeric phtalocyanine, they promote slightly less strong interactions with the small molecules they electronically attract.

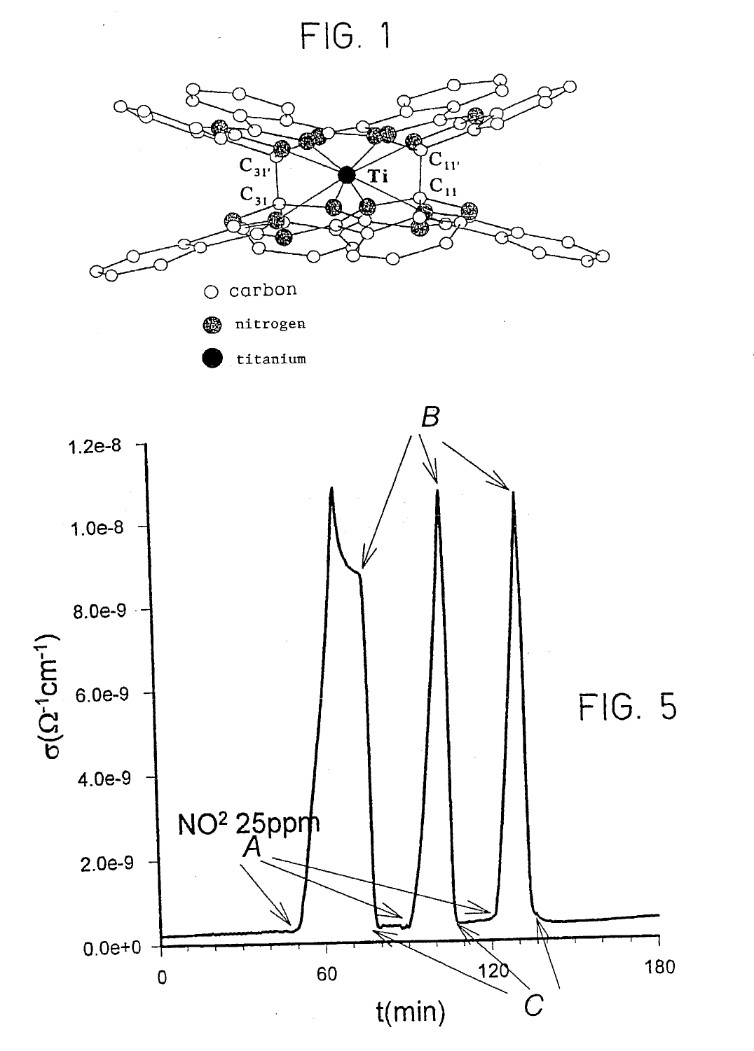

By way of exemplification, not by way of imitation, a phtalocyanine derivative is titanium bis-phtalocyaninate (TiPc₂) as described in C. Ercolani, A. M. Paoletti, G. Pennesi, G. Rossi, A. Chiesi-Villa and C. Rizzoli, J. Chem. Soc. Dalton Trans., 1999, pp. 1971-1977, having the sandwich crystal structure a side view of which is shown in FIG. 1.

The titanium bis-phtalocyaninate interacts with the nitrogen dioxide (NO₂) molecule, consequently changing its optical density or electric conductivity characteristics.

As described in A. Capobianchi, A. M. Paoletti, G. Pennesi. G. Rossi, Sensors and Actuators B48, 1998, pp. 333-338, the interaction develops by generating a charge coupling complex as described by the two following subsequent oxidation balances:

TiPc₂+NO₂? (TiPc₂+NO₂⁻) [1]

(TiPc₂⁺NO₂⁻)+NO₂? (TiPc₂⁺⁺NO₂⁻) [2]

Balance [1] is the one that is first established and is irreversible at room temperature: re-establishment of the initial conditions by desorption of nitrogen dioxide is effected by means of a vacuum treatment at a temperature of about 120° C.

The second balance [2] of course is reversible at room temperature, but a complete re-establishment of the initial conditions is achieved only after a time delay which turns out to be of a higher amount with respect to the amount usually demanded by the usual application requirements of a sensor.

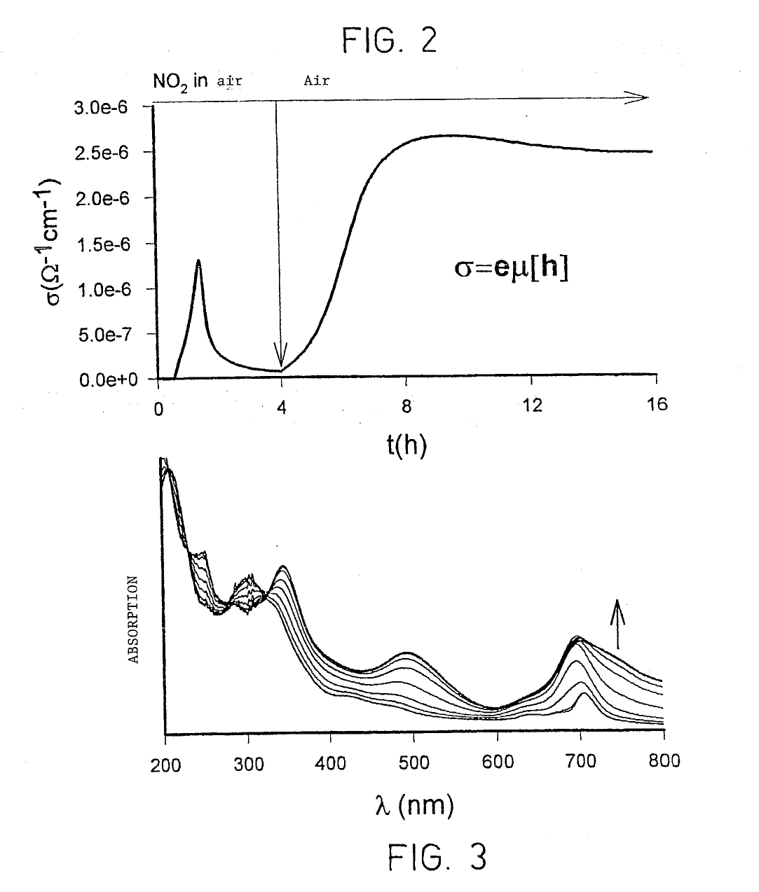

FIG. 2 shows the time behavior of the conductivity a for titanium bis-phtalocyaninate exposed, during a first four hour time interval to 10 ppm nitrogen dioxide in air and, starting from the fourth hour, to pure air. In particular, the first portion of said time behavior, associated to the first four hour time interval, is due to predominance of the first balance [1], while the subsequent portion is due to predominance of the second balance [2].

The above discussed behavior of the conductivity, which also characterizes other phtalocyanine complexes having a “sandwich” type crystal structure, evidences that use of titanium bis-phtalocyaninate as a sensitive component of a conductivity measure based sensor appears to be unfeasible, due to a number of overlapping effects. As a matter of fact, the species accounting for conduction of electric current in both balances [1] and [2] is the mono-cationic one (TiPc₂⁺NO₂⁻) and also that its concentration strongly depends on the reversibility of the above balances themselves, the essential irreversibility of the first balance [1] makes use of titanium bis-phtalocyaninate hardly feasible in conductivity measure based applications for detection of nitrogen dioxide.

FIG. 3 shows the kinetics of the absorption spectra of titanium bis-phtalocyaninate as a function of the time, when it is exposed to a constant concentration of nitrogen dioxide.

As described in F. Baldini, A. Capobianchi, A. Falay, G. Giannesi, Sensors and Actuators B51, 1998, pp. 176-180, when the second balance [2] between the bis-cationic species (TiPc₂⁺⁺2NO₂⁻) and the mono-cationic species (TiPc₂^{+NO}₂⁻) is exploited as a basic principle for optical detection of nitrogen dioxide, it is possible to utilize titanium bis-phtalocyaninate as a sensitive component of an optical sensor, provided with suitable optical detection devices, of course, such as, for instance, an optical fiber bundle coupled to a spectrophotometer and to a light source. In fact, even if the exploitation of the intrinsic reversibility of the second balance [2] at room temperature is slow, it offers the possibility to control such optical sensor.

Anyway, even if the phtalocyanine derivatives, such as titanium bis-phtalocyaninate, are extremely selective, their above illustrated characteristics inhibit their utilization in the sensor field.

The main drawback is due to the fact that the interactions between the phtalocyanine derivatives, also including the not-monomeric phtalocyanine, and the chemical substances with which they react are not completely reversible at room temperature.

As above illustrated, the use of titanium bis-phtalocyaninate as a sensitive component of a conductivity measure based sensor for nitrogen dioxide turns out to be unfeasible just in view of the irreversibility of the interactions due to the first balance [1]. On the other hand, as it is shown in FIG. 2, the noticeable variation in conductivity a, when the interaction is mainly due to the first oxidation balance [1], would make a conductivity measure based sensor using titanium bis-phtalocyaninate also responsive to extremely low concentrations of the concerned nitrogen dioxide.

Therefore, a complete reversibility of the interactions between not-monomeric phtalocyanine and/or phtalocyanine derivatives and the chemical substances with which they interact could be obtained only by carrying out high temperature treatments, but this would entail a degradation of the properties of the crystal structures, thereby reducing their reliability and duration, increasing their economic costs and establishing potentially dangerous operation conditions.

In this context, the approach suggested by this invention is to be considered to enable all above mentioned problems to be solved.

It is an object of this invention, therefore, to make the interactions between not monomeric phtalocyanine and/or phtalocyanine derivatives and the chemical substances with which they interact substantially completely reversible at room temperature.

A further object of this invention is to furnish an absorbent structure that is extremely selective in respect of a specific gaseous chemical substance, highly sensitive, substantially completely reversible at room temperature, long lasting, reliable, easily manufacturable and economically convenient.

It is also an object of this invention to furnish an optical or a conductivity measure based sensor, preferably for detection of nitrogen dioxide, that is selective, highly sensitive, so as to detect also extremely low concentrations of the chemical substance with which it interacts, substantially completely reversible at room temperature, long lasting, reliable, easily manufacturable and economically convenient.

It is a specific object of this invention to provide an absorbent structure comprising a sensitive component, provided with a thin film layer of not monomeric phtalocyanine and/or phtalocyanine derivatives, and a light source, arranged in such a position as to be adapted to irradiate said thin film layer of the sensitive component, the thickness of said thin film layer being not greater than 100 nanometers, preferably not greater than 50 nanometers, even more preferably not greater than 10 nanometers, said light source emitting light having a wavelength in the range of 180 to 600 nanometers, preferably in the range of 300 to 500 nanometers, even more preferably in the range of 380 to 420 nanometers.

Preferably according to this invention, the thin film layer comprises not monomeric phtalocyanine and/or oligomers of phtalocyanine and/or polymers of phtalocyanine and/or complexes with sandwich type crystal structure and/or complexes with bridge crystal structure.

Further according to this invention, the light source can be provided with at least one light emitting diode or LED.

Also according to this invention, at least said sensitive component can be arranged in a gas permeable chamber.

Further according to this invention, the thin film layer can comprise titanium bis-phtalocyaninate (TiPc₂).

Also according to this invention, the absorbent structure can be employed in a conductivity measure based sensor also comprising an electronic device coupled to the sensitive component of said absorbent structure in order to detect its electrical conductivity, preferably to detect the presence of nitrogen dioxide.

Still according to this invention, the absorbent structure can be utilized in an optical sensor also comprising a photodetector, preferably provided with a silicon photodiode, coupled to said sensitive component, preferably to detect the presence of nitrogen dioxide.

It is a further object of this invention to provide a process for regenerating an absorbent structure comprising a sensitive component provided with a thin film layer of not monomeric phtalocyanine and/or phtalocyanine derivatives, the thickness of said thin film layer being not grater than 100 nanometers, preferably not greater than 50 nanometers, even more preferably not greater than 10 nanometers, the regeneration process comprising irradiating said thin film layer of said sensitive component with light having a wavelength in the range of 180 and 600 nanometers, preferably in the range of 300 to 500 nanometers or 200 to 420 nanometers, even more preferably in the range of 380 to 420 nanometers.

Preferably according to this invention, said thin film layer comprises not monomeric phtalocyanine and/or oligomers of phtalocyanine and/or polymers of phtalocyanine and/or complexes with sandwich type crystal structure and/or complexes with bridge crystal structure.

Additionally according to this invention, said thin film layer comprises titanium bis-phtalocyaninate (TiPc₂).

Preferably, according to this invention, the regeneration process is carried out at room temperature.

This invention will be now described by way of illustration and not by way of limitation according to its preferred embodiments, by particularly referring to the Figures of the enclosed drawings, in which:

FIG. 1 shows a side view of the crystal structure of titanium bis-phtalocyaninate (TiPc₂);

FIG. 2 shows the time behavior of the conductivity for titanium bis-phtalocyaninate in the presence of air and partially of nitrogen dioxide;

FIG. 3 shows the kinetics of the absorption spectra for titanium bis-phtalocyaninate as a function of time, when it is exposed to a constant concentration of nitrogen dioxide;

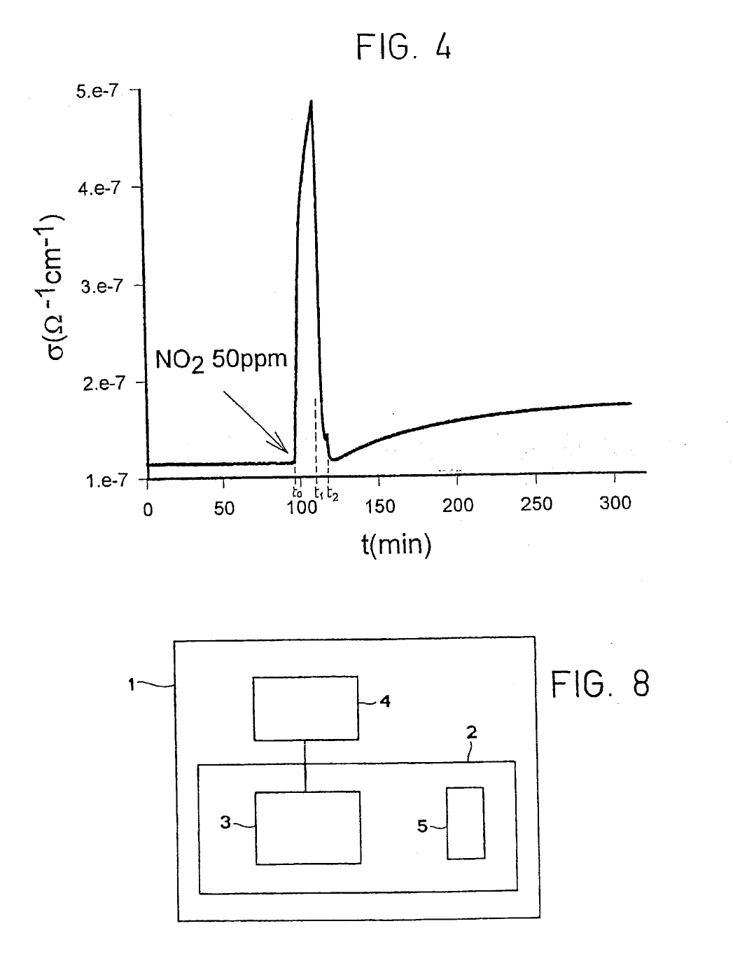

FIG. 4 shows the time behavior of the conductivity for titanium bis-phtalocyaninate once exposed to nitrogen dioxide and subjected to a regeneration process according to this invention;

FIG. 5 shows the time behavior of the conductivity for titanium bis-phtalocyaninate plural times exposed to the same concentration of nitrogen dioxide and each time subjected to a regeneration process according to this invention;

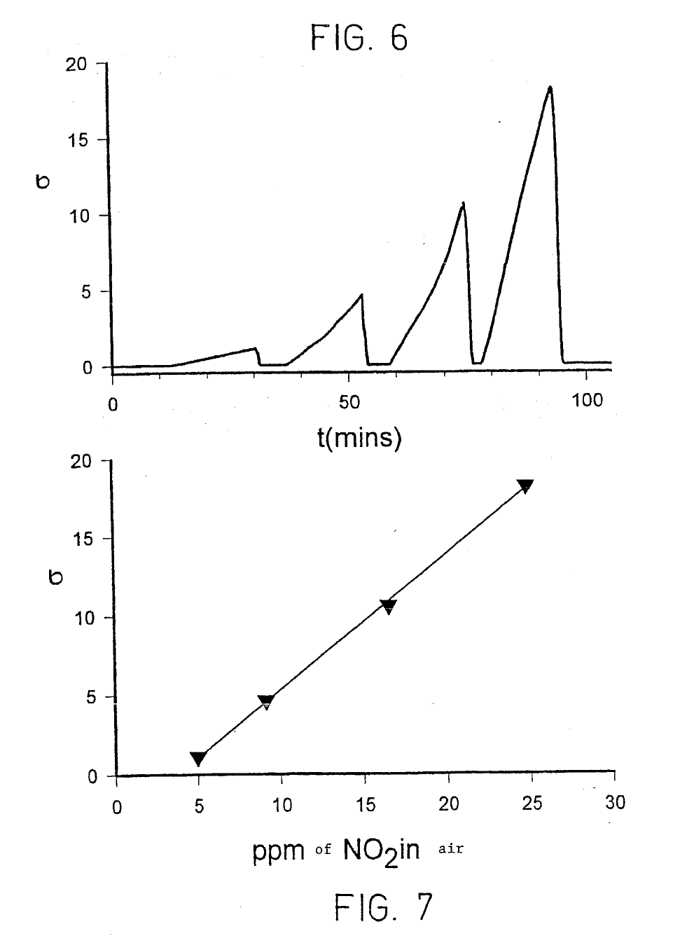

FIG. 6 shows the time behavior of the conductivity for titanium bis-phtalocyaninate plural times exposed to variable concentrations of nitrogen dioxide and each time subjected to a regeneration process according to this invention;

FIG. 7 shows the calibration straight line, obtained from the behavior of FIG. 6, for titanium bis-phtalocyaninate as a function of the nitrogen dioxide concentration to which it is exposed;

FIG. 8 shows a block diagram of a sensor according to this invention.

This invention will be described hereinafter by particularly referring to titanium bis-phtalocyaninate and to its interaction with nitrogen dioxide. It should, however, be noted that all that will be discussed also applies to not-monomeric phtalocyanine and to other phtalocyanine derivatives, other than titanium bis-phtalocyaninate, and to their interactions with chemical substances other than nitrogen dioxide, the scope of this invention including not-monomeric phtalocyanine as well as all phtalocyanine derivatives, in particular oligomers (for instance, dimers), polymers, complexes with sandwich crystal structure and complexes with bridge crystal structure.

By illustrative and not restrictive reference to titanium bis-phtalocyaninate, the inventors in this invention have developed a process adapted to make the interaction between this phtalocyanine derivative and this nitrogen dioxide reversible at room temperature.

In fact, a complete drop in the electric conductivity of a thin film layer of titanium bis-phtalocyaninate can be obtained by irradiating said thin film layer subjected to interaction with nitrogen dioxide with light included in the violet and/or ultraviolet spectrum, at any time during said interaction. In particular, the wavelength of the radiation is in the range of 180 to 600 nanometers, preferably in the range of 300 to 500 nanometers or in the range of 200 to 420 nanometers, even more preferably in the range of 380 and 420 nanometers. The thickness of the thin film layer is not greater than 100 nanometers, preferably not greater than 50 nanometers and even more preferably not greater than 10 nanometers.

The radiation causes an immediate photolysis of the charge coupling complex comprising the titanium bis-phtalocyaninate and the nitrogen dioxide, thereby promoting a desorption of the nitrogen dioxide and consequently a regeneration of the starting thin film layer and causing a drop in the electric conductivity and optical density parameters of the concerned titanium bis-phtalocyaninate.

FIG. 4 shows the time behavior of the conductivity of titanium bis-phtalocyaninate exposed to air containing a concentration of 50 ppm (parts per million) of nitrogen dioxide and subjected to a regeneration process performed by irradiation according to this invention.

In particular, the exposition of the thin film layer of titanium bis-phtalocyaninate starts at time t₀, the irradiation of the layer starts at time t₁ and the irradiation ends at time t₂. It can be observed that the conductivity decrease extends even after the end of the irradiation, up to complete re-establishment of the initial conditions. The irradiation duration (t₂−t₁) needed to cause a complete desorption of nitrogen dioxide appears to be very short and depending on the irradiation power. In this respect, the time behavior of the conductivity in the layer during the preliminary exposition to nitrogen dioxide performed before the irradiation, namely in the time interval from time t₁ to time t₂, is a replica of the initial behavior, specifically related to the first peak, as shown in FIG. 2.

This specific regeneration process performed by irradiation of the thin film layer of titanium bis-phtalocyaninate, which results into a rapid and complete re-establishment of the initial conditions for both balances [1] and [2] which represent the interaction with nitrogen dioxide, upsets a consolidated technical prejudice. In effect, in the field of semiconductor oxide based sensors as well as in the research activity relating to monomeric phtalocyanine, the use of irradiation is a well known and utilized method for promoting a higher reactivity in the presence of interacting chemical substances, with consequent increase in the electrical conductivity, based upon exploitation of a n-type conduction mechanism.

The titanium bis-phtalocyaninate regeneration process according to this invention enables a thin film layer of such complex to be utilized in a conductivity measure based sensor for detecting nitrogen dioxide.

In particular, since the interaction between titanium bis-phtalocyaninate and nitrogen dioxide is completely reversible, it is possible to exploit the first balance [1], which is more sensitive than the second balance [2]. In effect, as it is shown by FIG. 2, the behavior of the electrical conductivity is much more rapid when it mainly depends on the first balance [1]. Therefore, a sensor that utilizes a thin film layer in which the first balance [1] is exploited appears to be extremely sensitive and it is adapted to detect even very low concentrations of nitrogen dioxide, in the magnitude order range of 100 ppb (parts per billion).

Furthermore, since the regeneration process according to this invention is carried out at room temperature, it does not affect the crystal structure properties of the thin film layer and, as a consequence hereof, it permits a very high number of operation cycles.

In particular, FIG. 5 shows the time behavior of the conductivity of a thin film layer of titanium bis-phtalocyaninate extended to three operation cycles. During each operation cycle, point A of the behavior line is related to the start point of the exposition of the thin film layer to air including a concentration of 25 ppm of nitrogen dioxide, point B is related to the starting point of the layer regeneration process (starting point of the irradiation) and point C is related to the end point of the regeneration process (complete desorption of the nitrogen dioxide). It can be observed that, at each operation cycle, the conductivity time behavior of the concerned layer during its exposition to nitrogen dioxide in preparation to the regeneration process (between points A and B) is an unchanged replica of the behavior illustrated in FIG. 2. In other words, the concerned titanium bis-phtalocyaninate completely recovers its properties at the end of each regeneration process and the characteristics of its interaction with nitrogen dioxide remain constant, thereby permitting reproducibility of this phenomenon.

Therefore, the regeneration process according to this invention also enables an accurate calibration of a conductivity measure based sensor utilizing a thin film layer of titanium bis-phtalocyaninate. In this respect, FIG. 6 shows the conductivity time behavior of a thin film layer of titanium bis-phtalocyaninate exposed many times to increasing concentrations of nitrogen dioxide ad each time subjected to a regeneration process. Taking the behavior illustrated in FIG. 6, it is possible to draw the calibration straight line illustrated in FIG. 7 which shows the conductivity of this thin film layer as a function of the nitrogen dioxide concentration.

As a result of the regeneration process according to this invention, titanium bis-phtalocyaninate can be embodied in absorbent structures useable in various applications.

In particular, FIG. 8 illustrates a block diagram of a preferred embodiment of such absorbent structure utilized in a conductivity measure based sensor of nitrogen dioxide.

Sensor 1 comprises an absorbent structure 2 incorporating a sensitive component 3, provided with thin film layer of titanium bis-phtalocyaninate, coupled to an electronic device 4, that detects its electrical conductivity, as well as a light source 5, preferably provided with at least a light emitting diode or LED, adapted to irradiate the sensitive component 3. Light source 5 is preferably adapted to emit light having a wavelength in the range of 200 to 420 nanometers, even more preferably in the range of 380 and 420 nanometers. In detail, at least said sensitive component 3 is arranged in a gas permeable chamber.

Other embodiments of the absorbent structure according to this invention can be employed as optical sensors. In this case, the concerned sensor comprises a photodetector, preferably including a silicon photodiode, in stead of the conductivity detecting electronic device 4.

Further embodiments of the absorbent structure according to this invention can be utilized in applications other than a sensor based detection application. For instance, such an absorbent structure can be utilized in a catalysis application or as a reversible chemical filter, adapted to absorb nitrogen dioxide, for instance in the case of titanium bis-phtalocyaninate, as well as to be optically controllable.

This invention has been described with particular reference to an absorbent structure comprising a thin film layer of titanium bis-phtalocyaninate and to its interaction with nitrogen dioxide. It should, however, be understood that the regeneration process according to this invention can also be applied to absorbent structures comprising not-monomeric phtalocyanine and/or other phtalocyanine derivatives, other than titanium bis-phtalocyaninate, such as oligomers (for instance dimers), polymers, complexes with sandwich type crystal structure and complexes with bridge crystal structure, and to their interactions with chemical substances other than nitrogen dioxide, without so departing from the scope of this invention.

The preferred embodiments of this invention have been described and a number of variations have been suggested hereinbefore, but it should expressly be understood that those skilled in the art can make other variations and changes, without so departing from the scope thereof, as defined in the following claims.

1. An absorbent structure (2) comprising a sensitive component (3), provided with a thin film layer of not monomeric phtalocyanine and/or phtalocyanine derivatives, and a light source (5), arranged in such a position as to be adapted to irradiate said thin film layer of the sensitive component (3), the thickness of said thin film layer being not greater than 100 nanometers, said light source emitting light having a wavelength in the range of 180 to 600 nanometers.

2. An absorbent structure (2) according to claim 1, characterized in that said thin film layer comprises not-monomeric phtalocyanine and/or oligomers of phtalocyanine and/or polymers of phtalocyanine and/or complexes with sandwich type crystal structure and/or complexes with bridge crystal structure.

3. An absorbent structure (2) according to claim 1 or 2, characterized in that said light source emits light having a wavelength in the range of 300 to 500 nanometers.

4. An absorbent structure (2) according to claim 1 or 2, characterized in that said light source emits light having a wavelength in the range of 200 to 400 nanometers.

5. An absorbent structure (2) according to claim 4, characterized in that said light source emits light having a wavelength in the range of 380 to 420 nanometers.

6. An absorbent structure (2) according to any one of the preceding claims, characterized in that the thickness of said thin film layer is not greater than 50 nanometers.

7. An absorbent structure (2) according to claim 6, characterized in that the thickness of said thin film layer is not greater than 10 nanometers.

8. An absorbent structure (2) according to any one of the preceding claims, characterized in that said light source (5) is provided with at least one light emitting diode or LED.

9. An absorbent structure (2) according to any one of the preceding claims, characterized in that at least said sensitive component (3) is arranged in a gas permeable chamber.

10. An absorbent structure (2) according to any one of the preceding claims, characterized in that said thin film layer comprises titanium bis-phtalocyaninate (TiPc₂).

11. A conductivity measure based sensor (1) comprising an absorbent structure (2) according to any one of the preceding claims and an electronic device (4) coupled to the sensitive component (3) of said absorbent structure (2) in order to detect its electrical conductivity.

12. A conductivity measure based sensor (1) according to claims 10 and 11, characterized in that it operates as a conductivity measure based sensor to detect the presence of nitrogen dioxide.

13. An optical sensor comprising an absorbent structure (2) according to any one of claims 1 to 10, characterized in that it also comprises a photodetector coupled to said sensitive component (3).

14. An optical sensor according to claim 13, characterized in that said photodetector comprises a silicon photodiode.

15. An optical sensor according to claims 10 and any one of claims 13 or 14, characterized in that it operates as an optical sensor to detect the presence of nitrogen dioxide.

16. A process for regenerating an absorbent structure (2) comprising a sensitive component (3) provided with a thin film layer of not-monomeric phtalocyanine and/or phtalocyanine derivatives, the thickness of said thin film layer being not grater than 100 nanometers, the regeneration process comprising irradiating said thin film layer of said sensitive component (3) with ultraviolet light having a wavelength in the range of 180 and 600 nanometers.

17. A regeneration process according to claim 16, characterized in that said thin film layer comprises not-monomeric phtalocyanine and/or oligomers of phtalocyanine and/or polymers of phtalocyanine and/or complexes with sandwich type crystal structure and/or complexes with bridge crystal structure.

18. A regeneration process according to claim 16 or 17, characterized in that the light with which the thin film layer of said sensitive component (3) is irradiated has a wavelength in the range of 300 to 500 nanometers.

19. A regeneration process according to claim 16 or 17, characterized in that the light with which the thin film layer of said sensitive component (3) is irradiated has a wavelength in the range of 200 to 420 nanometers.

20. A regeneration process according to claim 19, characterized in that the light with which the thin film layer of said sensitive component (3) is irradiated has a wavelength in the range of 380 to 420 nanometers.

21. A regeneration process according to any one of claims 16 to 20, characterized in that the thickness of said thin film layer is not greater than 50 nanometers.

22. A regeneration process according to claim 21, characterized in that the thickness of said thin film layer is not greater than 10 nanometers.

23. A regeneration process according to any one of claims 16 to 22, characterized in that it is carried out at room temperature.

24. A regeneration process according to any one of claims 16 to 23, characterized in that said thin film layer comprises titanium bis-phtalocyaninate (TiPc₂).
